(19) United States
(12) Patent Application Publication
(10) Pub. No.: US 2002/0100496 A1
(43) Pub. Date: Aug. 1, 2002

(54) Apparatus for cleaning wafers

(76) Inventor: Hong Tai Chang, Chong Ho City (TW)

Correspondence Address: Hong Tai Chang, 6F, No. 440-2, Gin Pin Road, Chong Ho City, 235, TW

(21) Appl. No.: 09/776,784

(22) Filed: Feb. 1, 2001

(51) Int. Cl. B08B 3/04

(52) U.S. Cl. 134/76; 134/902

(57) ABSTRACT

An apparatus for cleaning wafers includes one or more rows of receptacles for receiving cleaning agents or water The wafers are moved through and downward into the receptacles one by one for allowing the wafers to be cleaned by the cleaning agents first and then cleaned by the water. A vacuuming device may be used for drawing the air of the cleaning agent out of the apparatus. The wafers may be grasped between two grasping arms and separated from each other and moved through the receptacles. About 50 wafers may be cleaned once at a time.

### BACKGROUND OF THE INVENTION

1. Field of the Invention

The present invention relates to a cleaning apparatus, and more particularly to an apparatus for cleaning wafers.

2. Description of the Prior Art

Various kinds of typical wafer cleaning devices have been developed and comprise one or more chambers for receiving the wafers to be washed or cleaned. However, the typical chambers are normally designed for receiving the wafers having a predetermined size or diameter, and may not be used for cleaning the wafers having the other sizes or diameters.

The present invention has arisen to mitigate and/or obviate the afore-described disadvantages of the conventional wafer cleaning devices.

### SUMMARY OF THE INVENTION

The primary objective of the present invention is to provide a wafer cleaning apparatus for cleaning various kinds of wafers.

In accordance with one aspect of the invention, there is provided an apparatus comprising a plurality of wafers, a first receptacle for receiving a cleaning agent and a second receptacle for receiving water and for receiving the wafers to clean the wafers, and means for moving the wafers toward and into the first and the second receptacles to clean the wafers.

The cleaning agent is a chemical solution. A housing is further provided for receiving the first and the second receptacles, and means for drawing air out of the housing.

The wafer moving means includes a carrier box for receiving the wafers, means for elevating the wafers, means for grasping the wafers, and means for transferring the wafers toward and into the first and the second receptacles.

The grasping means includes a pair of grasping arms, and means for forcing the grasping arms to grasp the wafers. The grasping arms each includes a plurality grooves formed therein for receiving and retaining the wafers.

The transferring means includes a track, a pair of grasping arms, and moving the grasping arms along the track and toward the first and the second receptacles. A device is provided for cleaning the grasping arms.

The grasping arms moving means includes a first rod and at least one second rod, a pair of first limbs secured to the second rod, a pair of second limbs slidably secured on the first rod and the second rod, and means for adjusting the first limbs relative to the second limbs.

A retainer is secured between the first limbs and having a plurality of slots formed therein for receiving and retaining the wafers. A device is provided for adjustably securing the second limbs relative to the first rod to any selected angular position.

The adjustably securing means includes two blocks secured on the first rod, and two fasteners threaded to the second limbs respectively and engaged with the blocks respectively for adjusting the second limbs relative to the first rod to any selected angular position.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a top plane view of a wafer cleaning apparatus in accordance with the present invention;

FIG. 2 is a front elevational view of the wafer cleaning apparatus;

FIGS. 3, 4, 5 are cross sectional views taken along lines 3-3, 4-4, and 5-5 of FIG. 1 respectively;

FIG. 6 is an enlarged partial cross sectional view of that shown in FIG. 4;

FIGS. 7, 8 are cross sectional views taken along lines 7-7, and 8-8 of FIG. 6 respectively;

FIGS. 9, 10 are cross sectional views taken along lines 9-9, and 10-10 of FIGS. 7 and 8 respectively;

FIG. 11 is a cross sectional view taken along lines 11-11 of FIG. 1;

FIGS. 12, 13 are enlarged partial cross sectional views taken along lines 12-12, and 13-13 of FIG. 11 respectively;

FIG. 14 is an enlarged partial cross sectional view illustrating the device for supporting the wafers; and

FIG. 15 is an enlarged partial cross sectional view illustrating the cleaning device for the wafers.

### DETAILED DESCRIPTION OF THE PREFERRED EMBODIMENT

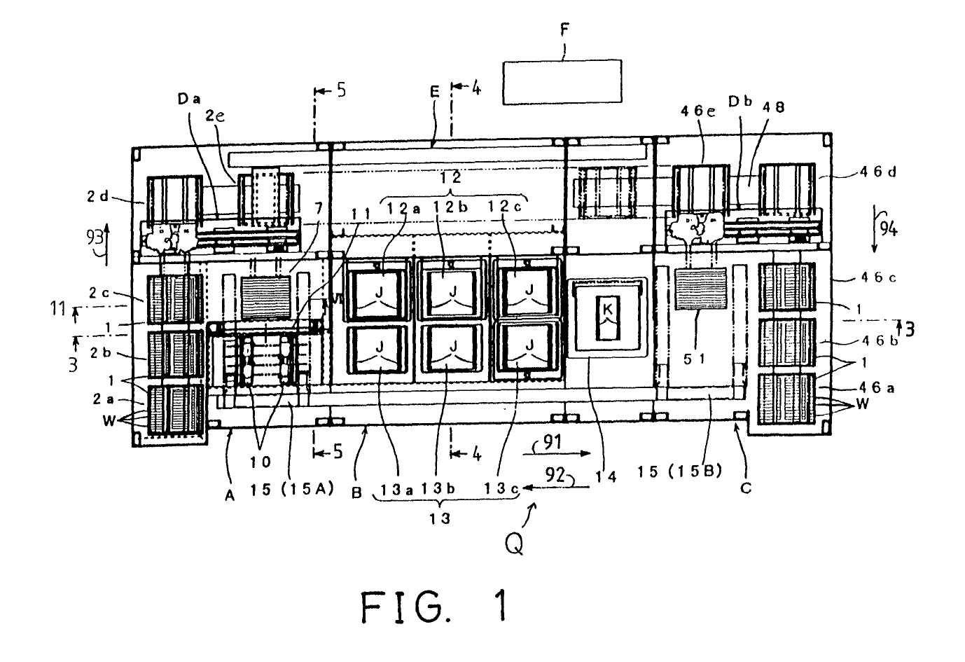

Referring to the drawings, and initially to FIGS. 1-3, a wafer cleaning apparatus in accordance with the present invention is provided for cleaning a number groups of wafers W group by group, each group of the wafers W comprises 50 pieces of wafers W, for example, received in a carrier box 1; i.e., a number of carrier boxes 1 are provided for receiving the wafers W and each may be used for receiving 50 pieces of the wafers W, for example. The water cleaning apparatus comprises a housing Q including a cleaning station B. a loading station A having a moving device Da for loading or feeding the wafers W from the loading station A into the cleaning station B, and a unloading station C having another moving device Db for unloading the wafers W from the cleaning station B to the unloading station C after the cleaning operations. A moving device E may be used to move the empty carrier boxes 1 between the stations A, B, C, and a control device F may be used for controlling the operation of the wafer cleaning apparatus.

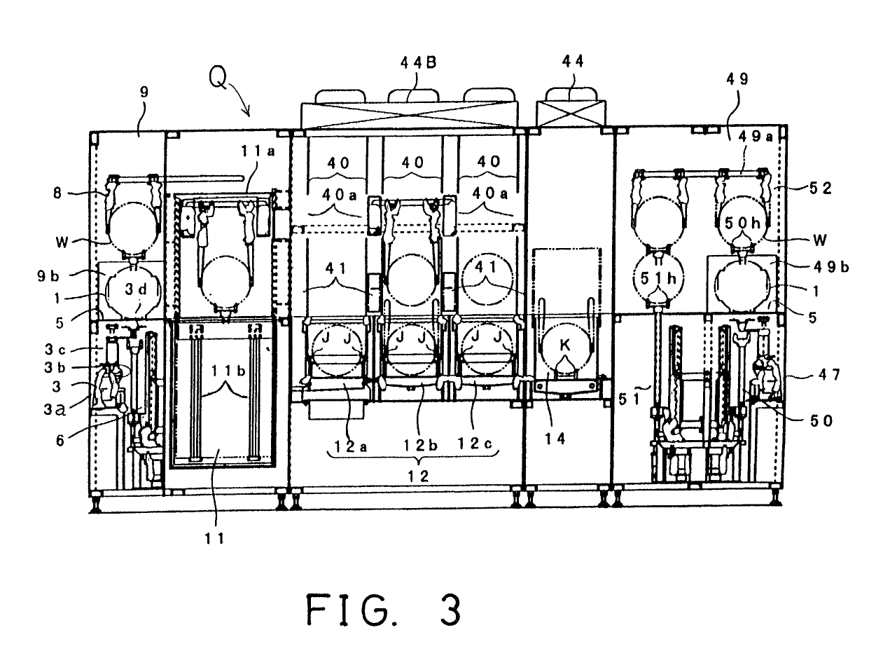

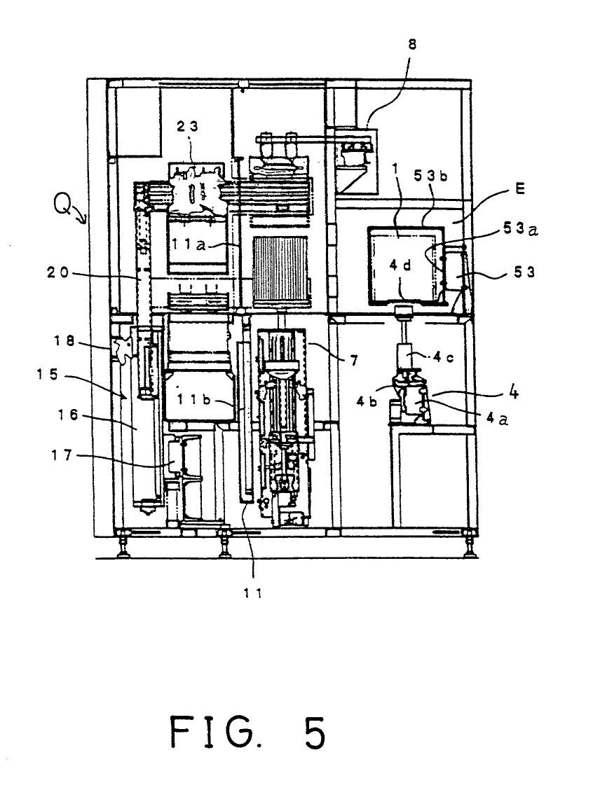

The housing Q includes a number of supporting stations 2a, 2b, 2c, 2d, 2e for receiving or supporting the carrier boxes 1. A conveyer device 3 (FIGS. 1, 3) may be used to move the carrier boxes 1 between the supporting stations 2a, 2b, 2c, 2d, and another conveyer device 4 (FIGS. 1, 5) may be used to move the carrier boxes 1 between the supporting stations 2d and 2e. As best shown in FIG. 3, a plate 5 is horizontally disposed in the middle portion of the housing Q for supporting the conveyer devices 3, 4 and for defining the supporting stations 2a-2e. As shown in FIG. 3, the conveyer device 3 includes a horizontal track 3a disposed in the housing Q, a carriage 3b and an actuator 3c, such as a pneumatic or hydraulic cylinder, disposed on and movable along the track 3a, and a seat 3d disposed on the actuator 3c for carrying and moving the carrier boxes 1. As shown in FIG. 5, the conveyer device 4 also includes a horizontal track 4a disposed in the housing Q, a carriage 4b and an actuator 4c, such as a pneumatic or hydraulic cylinder, disposed on and movable along the track 4a, and a seat 4d disposed on the actuator 4c for carrying and moving the carrier boxes 1.

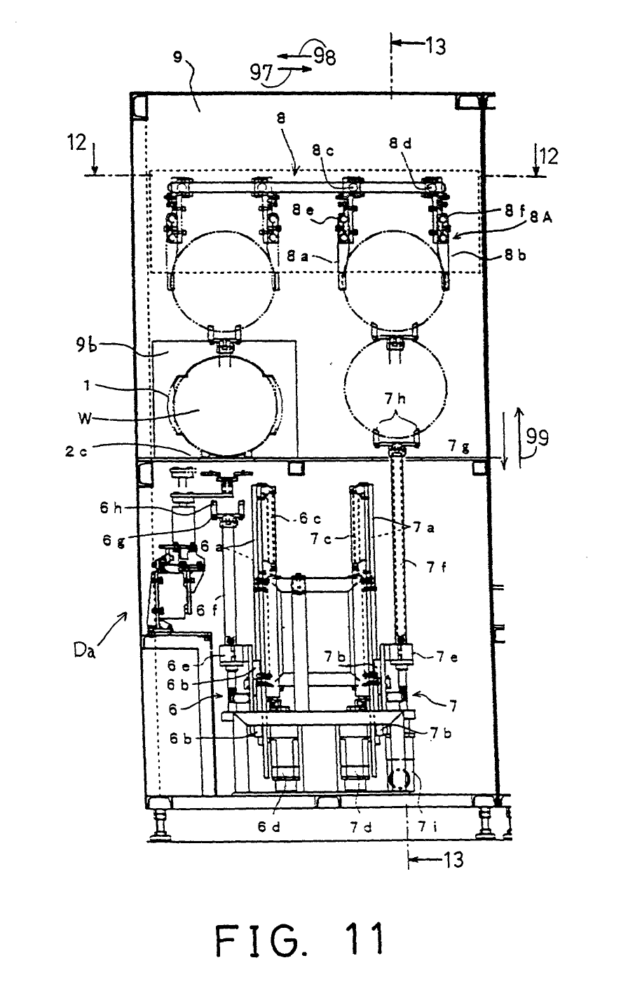

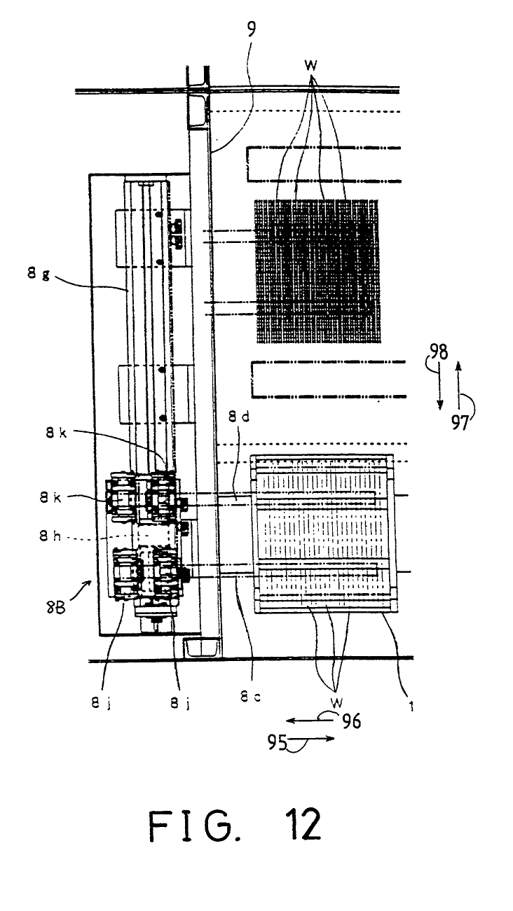

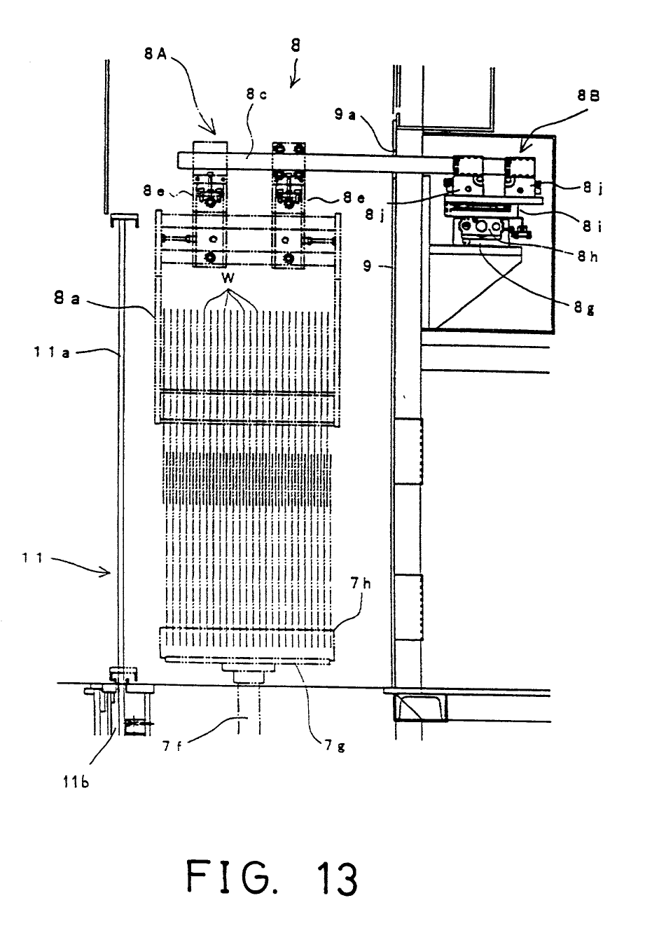

As shown in FIGS. 11-13, the moving device Da (FIG. 1) includes an elevating device 6 (FIG. 11) for moving the carrier boxes I upward and downward, a retaining device 7 for aligning the carrier boxes 1, and a transferring device 8 (FIGS. 12, 13) for moving the carrier boxes 1. As shown in FIG. 11, the elevating device 6 includes two horizontal tracks 6b, and two vertical tracks 6a slidably supported along the horizontal tracks 6b, a motor 6d disposed in the bottom of the housing Q and coupled to a block 6e with a bolt 6c for rotating the bolt 6c to move the block 6e up and down, and a post 6f secured on the block 6e for supporting a bracket 6g. The bracket 6g includes a supporting member 6h disposed thereon and having a number of grooves formed therein for receiving and supporting the wafers W for receiving 25 pieces of the wafers W. The distance between the grooves of the supporting member 6h are such as 10 mm, according to the distance between the carrier boxes 1.

The retaining device 7 includes two horizontal tracks 7b, and two vertical tracks 7a slidably supported along the horizontal tracks 7b, a motor 7d disposed in the bottom of the housing Q and coupled to a block 7e with a bolt 7c for rotating the bolt 7c to move the block 7e up and down, and a post 7f secured on the block 7e for supporting a bracket 7g. The bracket 7g includes a supporting member 7h disposed thereon and having a number of grooves formed therein for receiving and supporting the wafers W. The distance between the grooves of the supporting member 7h are such as 5 mm, about one half of the distance between the carrier boxes 1, for receiving 50 pieces of the wafers W, for example. A rotating device 7i may be used for rotating the post 7f.

As shown in FIG. 13, the transferring device S includes a grasping device SA and a driving device 8B separated from each other by a partition 9 that is provided in the housing Q. The grasping device SA includes a pair of grasping arms 8a, 8b for grasping the wafers W and coupled to two levers 8c, 8d with two brackets 8e, 8f respectively. As shown in FIGS. 12, 13, She driving device SB includes a track 8g, a carrier 8h slidably engaged on the track 8g and movable along the directions indicated by arrows 97, 98 (FIG. 12), one or more actuators 8i disposed on the carrier 8h, two or two pairs of actuators 8j, 8k disposed on or coupled to the actuators 8i so as to be moved along the directions indicated by arrows 95, 96 (FIG. 12). The levers 8c, 8d are coupled to the actuators 8j, 8k such that the grasping arms 8a, 8b may be used to grasp and move the wafers W along either the directions 95, 96 or 97, 98, by the driving device 8B via the levers 8c, 8d.

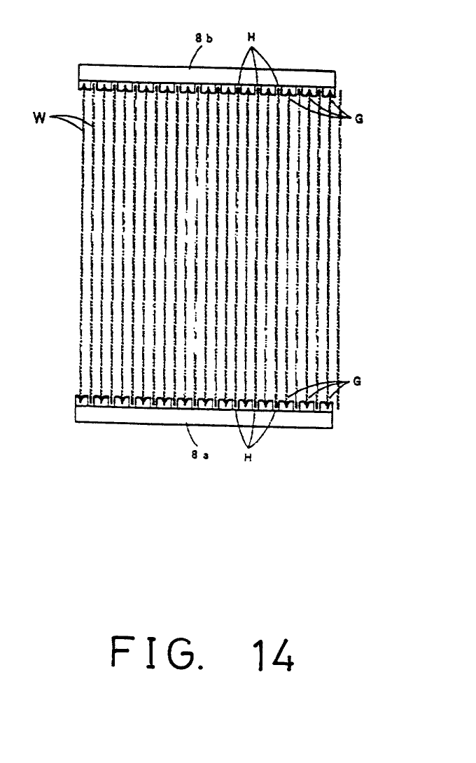

As best shown in FIG. 13, only the levers 8c, 8d are slidably engaged through the holes 9a of the partition 9, such that driving device SB may be suitably covered and shielded by the partition 9 and may be prevented from being dirtied. As shown in FIG. 14, the grasping arms 8a, 8b each includes a number of grooves G and H alternatively formed therein. The wafers W may be grasped and retained in the grooves G of the grasping arms 8a, 8b, but may not be grasped by the grasping arms 8a, 8b when the wafers W are received in the grooves H of the grasping arms 8a, 8b. The distance between the grooves G and H of the grasping arms 8a, 8b is 5 mm, for example, such that 25 pieces of the wafers W may be grasped by and between the grasping arms 8a, 8b and the other 25 pieces of the wafers W may not be grasped by and between the grasping arms 8a, 8b.

In operation, 25 pieces of the wafers W are received in a carrier box 1 which is disposed on the supporting station 2a manually or by the other moving or feeding devices. The conveyer device 3 may move the carrier box 1 and the wafers W to the other stations 2b or 2c. The supporting member 6h of the elevating device 6 may move the wafers W in the carrier box 1 upward along the directions indicated by arrows 99 (FIG. 11), such that the wafers W may be grasped by and between the grasping arms 8a, 8b of the grasping device 8A and by the actuators 8j, 8k via the levers 8c, 8d. The elevating device 6 may then be moved downward for elevating the other wafers W, after the wafers W have been grasped by the grasping arms 8a, 8b. After the wafers W have been removed from the carrier box 1, the hollow carrier box 1 may then be moved along a direction indicated by an arrow 93 (FIG. 1) and moved through an opening 9b (FIG. 11) of the partition 9 to the supporting station 2d. The wafers W may then be moved along the direction of the arrow 97 to the retaining device 7 and grasped by the supporting member 7h. The grasping arms 8a, 8b may be released and moved back to the original position for grasping the other wafers W after the wafers W have been grasped by or supported in the supporting member 7h which may then be rotated for 180 degrees by the rotating device 7i. The grasping device SA may then grasp and move the other 25 pieces of wafers W to the supporting member 7h and off-set from the previous 25 pieces of wafers W that are supported on the supporting member 7h, best shown in FIG. 13.

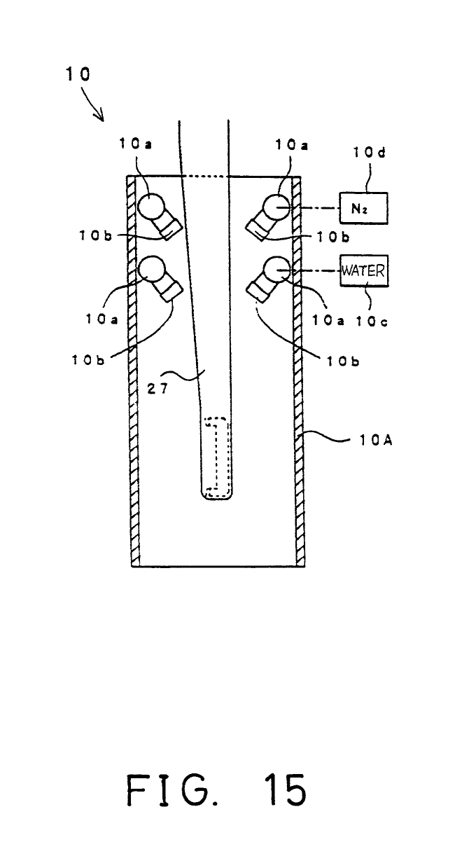

The housing Q includes a cleaning device 10 FIGS. 1, 15) for cleaning one or more grasping arms 27 which will be discussed hereinafter and which may grasp and move the wafers W through the wafer cleaning station B. The cleaning device 10 includes a peripheral wall 10A for enclosing or shielding the grasping arms 27, and includes one or more pumps 10a coupled to a water reservoir 10c for pumping the water out of the nozzles 10b to clean the grasping arms 27, and includes the other one or more pumps 10a coupled to a N₂ reservoir 10d for pumping the N₂ out of the nozzles 10b to clean or to blow the grasping arms 27. As shown in FIGS. 1, 3, 5, 13, a shielding device 11 includes a plate 11a coupled to and moved by one or more actuators 11b, in order to shield the wafers W and to prevent the wafers W from being splashed or dirtied by the water and N₂.

As shown in FIGS. 1 and 3, the cleaning station B is located in the middle portion of the housing Q and includes one or more rows of receptacles 12, 13 each having one or more receptacles 12a, 12b, 12c; 13a, 13b, 13c, and includes a drying device 14 for drying the cleaned wafers W. The receptacles 12a-12c are located in the inner or middle portion of the housing Q and distal to the workers and are provided for receiving the chemical solutions that is not good for and that may hurt people or the workers. The receptacles 13a-13c are located in the front portion of the housing Q and located closer to the workers and are provided for receiving the water which do no harm to the workers. The receptacles 12a-12c, and 13a-13c each includes a number of grooves or notches J formed therein for receiving and retaining the wafers W therein and for suitably spacing the wafers W from each other. A moving apparatus 15 includes two carriers 15A and 15B which are movable along the directions indicated by the arrows 91, 92 and the arrows 93, 94. The carrier 15A may be used for moving the wafers W to be cleaned along the direction 93 and between the receptacles 12 and 13 for allowing the wafers W to be cleaned by the chemical solutions received in the receptacles 12 and/or by the water received in the other receptacles 13, and may move the wafers W through the drying device 14. The other carrier 15B may be used for moving the wafers W that have been cleaned by the chemical solutions and/or water and that have been dried by the drying device 14, to the unloading station C.

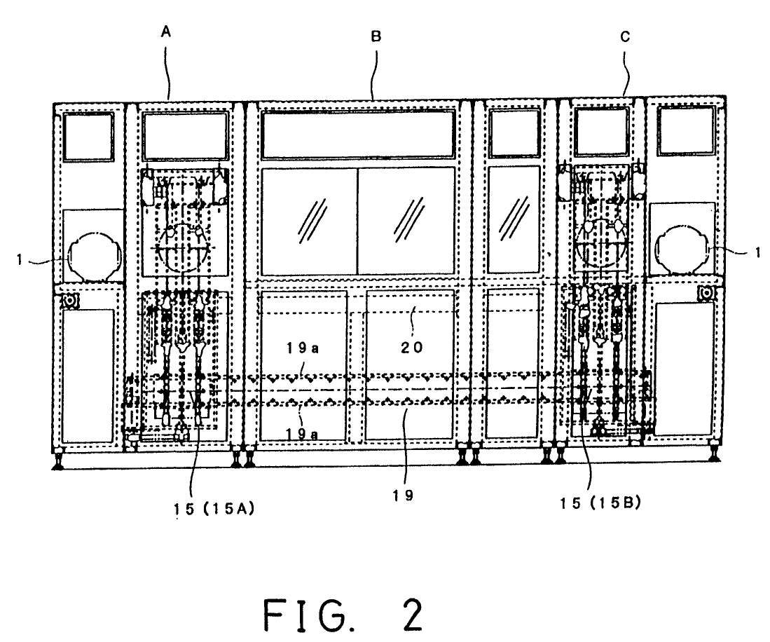

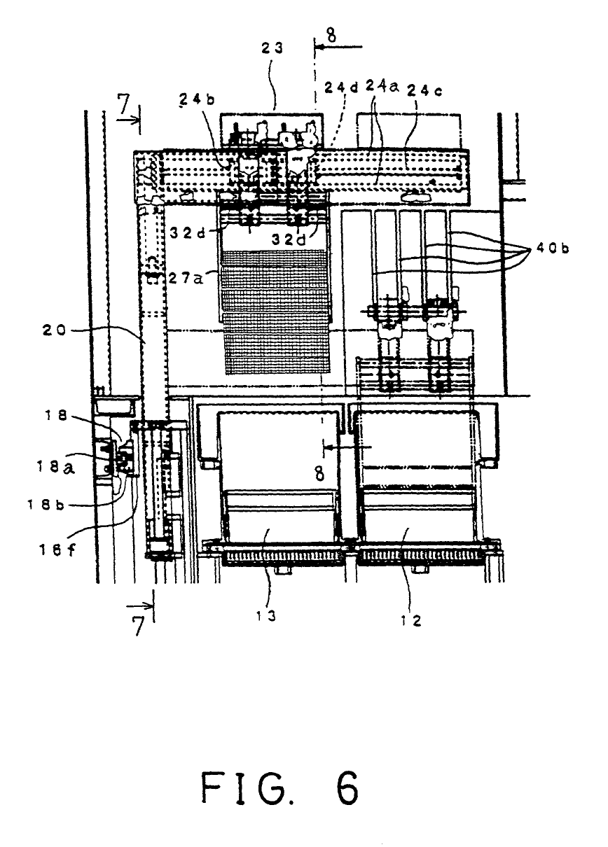

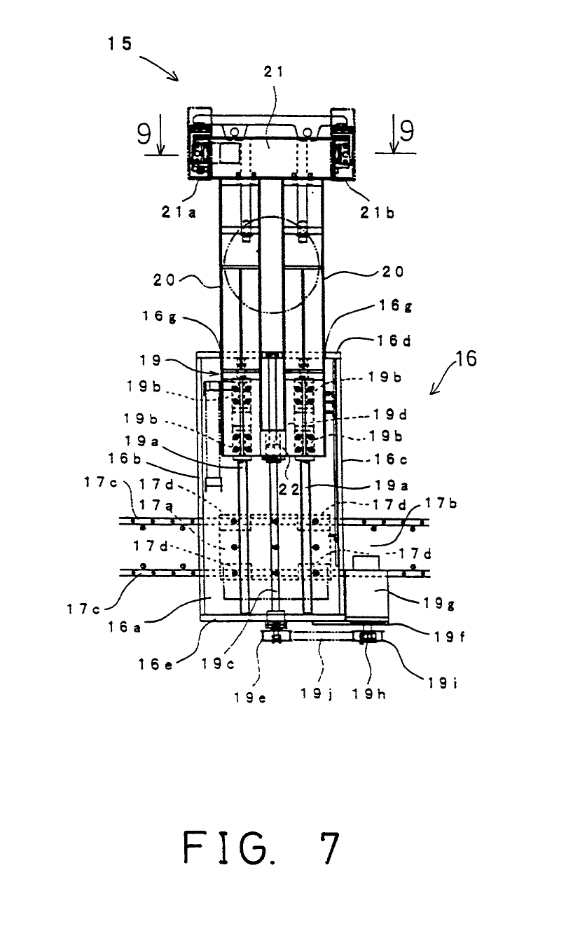

Referring next to FIGS. 2 and 4-7, the moving apparatus 15 includes a cabinet 16 having an elevating device 19 and a driving device 23, and having a carrier 18 slidably engaged on one or more tracks 18a (FIG. 6), and having a motor 17 secured on a follower 17a which is slidably engaged on the other tracks 17c (FIG. 7) with bearings or sleeves 17d. The carrier 18 includes a track 18b (FIG. 6) provided thereon. The cabinet 16 includes a side panel 16a secured to the follower 17a, four panels 16b, 16c, 16d, 16e secured to the side panel 16a to form a square or rectangular casing, and an extension 16f (FIG. 6) coupled to the track 18b, such that the cabinet 6 and the motor 17 may be slided along the tracks 18a, 17c.

The elevating device 19 includes four tracks 19a vertically secured to the side panel 16a, two poles 20 extended upward through the holes 16g of the upper panel 16d, a beam 21 secured on top of the poles 20, a bar 22 secured between the lower ends of the poles 20, a bolt 19c rotatably secured to the upper and bottom panels 16d, 16e, a nut 19d secured in the bar 22 and threaded to the bolt 19c, a motor 19g secured to the cabinet 16 with a bracket 19f and includes a pulley 19h coupled to another pulley 19e with a belt 19j or with a chain-and-sprocket coupling mechanism. The pulley 19e is secured to the bolt 19c such that the bolt 19c may be rotated by the motor 19g to move the poles 20 and the beam 21 up and down.

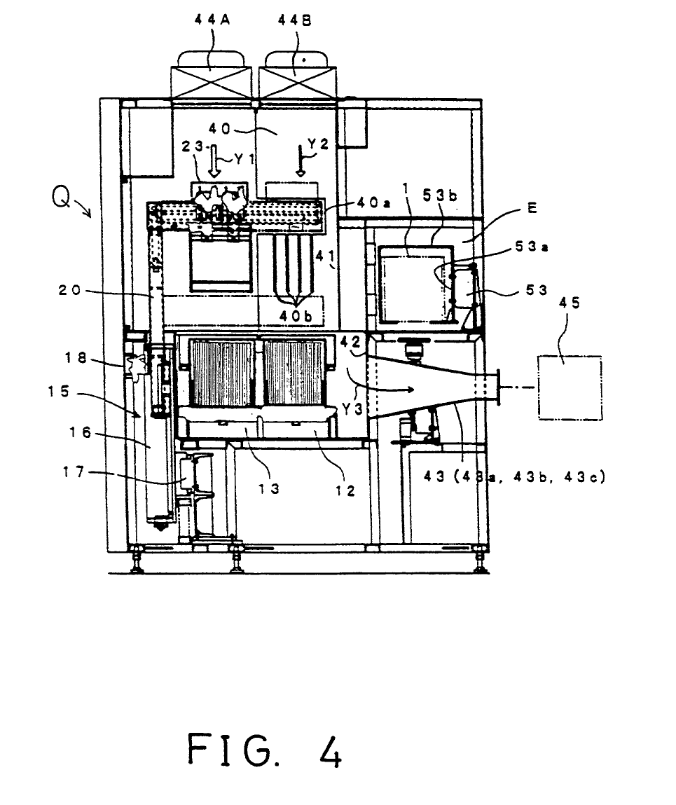

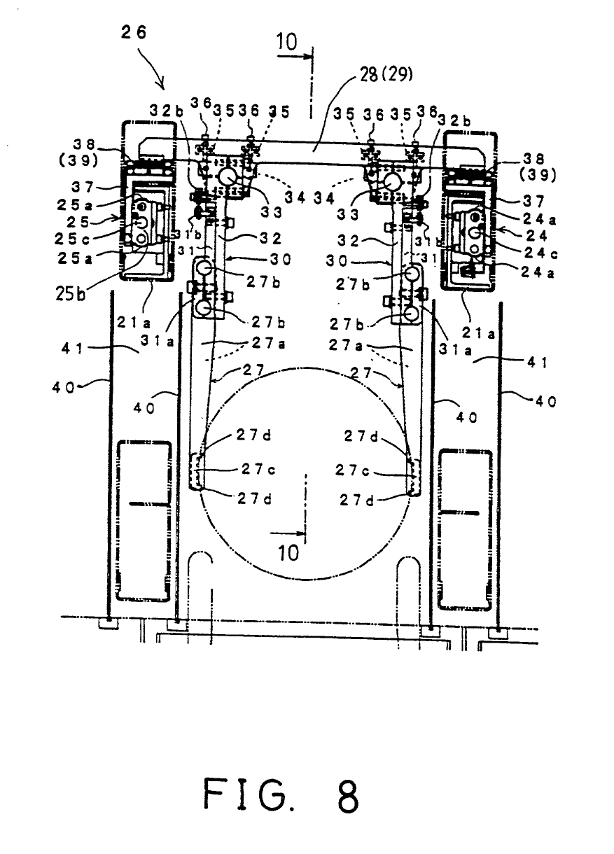

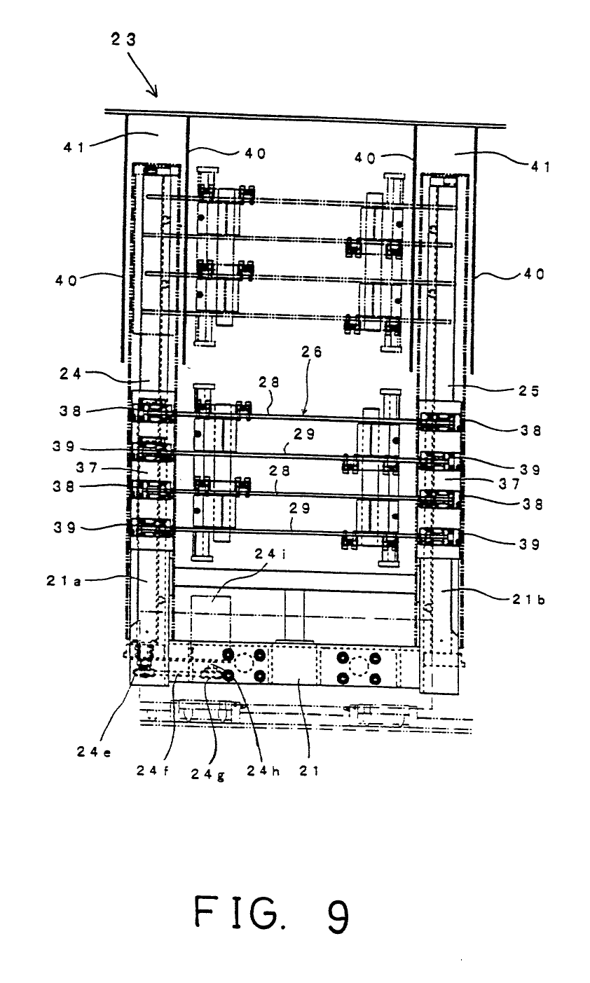

The driving device 23 (FIGS. 4-6) includes two legs 21a, 21b (FIGS. 7-9) secured on the beam 21, two movable devices 24, 25 received in the legs 21a, 21b, and a guiding device 26 provided between the movable devices 24, 25. The movable device 24 includes two tracks 24a (FIGS. 4, 8), a follower 24b slidably engaged on the tracks 24a and having a nut 24d secured therein, a bolt 24c rotatably secured between the tracks 24a and threaded with the nut 24d and having a pulley 24e (FIG. 9) coupled to a pulley 24g of a spindle 24h of a motor 24i with a belt 24f, such that the motor 24i may rotate the bolt 24c to move the follower 24b along the tracks 24a. The other movable device 25 also includes two tracks 25a (FIGS. 4, 8), a follower 25b slidably engaged on the tracks 25a and threaded with a bolt 25c.

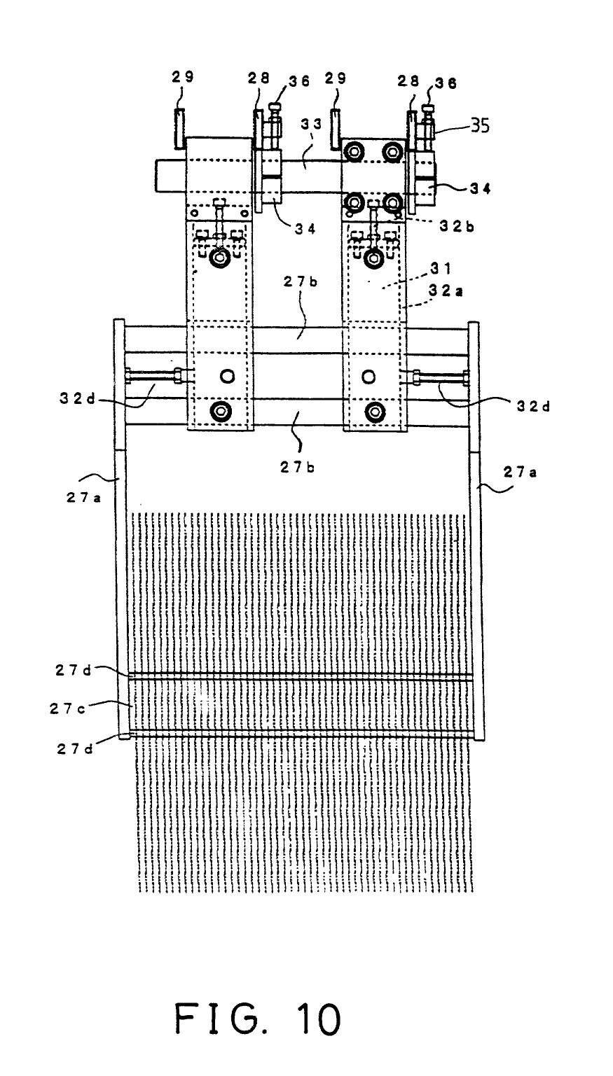

The guiding device 26 is similar to the grasping device 8A and also includes two pairs of shafts 28, 29. The grasping arms 27 are coupled to the shafts 28, 29 with securing devices 30 (FIG. 8). As shown in FIGS. 8 and 10, the grasping arms 27 each includes two rods 27b and a retainer 27c secured between two limbs 27a. The retainers 27c each includes a number of slots 27d formed therein for receiving and retaining the wafers W. Two pairs of limbs 31, 32 are slidably engaged on the rods 27b and another rod 33. The limb 32 includes a channel 32a (FIG. 10) formed therein for slidably receiving the body 31a of the other limb 31. Two bolts 31b may adjust and secure the limbs 31, 32 up and down relative to each other. Two blocks 34 are secured to the rod 33. The shafts 28, 29 each includes an extension 35 for threading with a bolt 36 which is adjustably engaged with the block 34 for adjusting the tilting angle of the grasping arms 27 relative to the shafts 28, 29 and for allowing the grasping arms 27 to be snugly grasp the wafers W. Two actuators or adjusting bolts 32d are engaged between the limbs 27a, 31, 32 for moving the limbs 31, 32 relative to the limbs 27a. Four cylinders or actuators 38 are secured on the shafts 28 and coupled to the track 24a with two brackets 37 and four other cylinders or actuators 39 are secured on the shafts 29 and coupled to the track 25a with two further brackets 37. The grasping arms 27 thus may be adjusted by the bolts 31b, 32b, and 36 to snugly grasp the wafers W and to move the wafers W through the cleaning station B and the drying device 14.

As shown in FIGS. 3, 4, 9, two boards 40 are provided between every two adjacent receptacles 12a-12c, another board 40 is disposed between the receptacle 12a and the loading station A, and a further board 40 is disposed between the receptacle 12c and the drying device 14. Two walls 41, 42 (FIG. 4) are disposed between the receptacles 12c and the moving device E. The wall 42 includes one or more guiding ducts 43, 43a, 43b, 43c coupled to a vacuuming device 45 which may drawing the airs through the filter devices 44, 44A, 44B. The air drawn through the filter devices 44A is preferably fastener than the air drawn through the filter device 44B, such that the air flows Y1, Y2 (FIG. 4) may be drawn out through the ducts 43, 43a-43c as the air flow Y3 and may prevent the vapor of the chemical solution from flowing to the workers.

As shown in FIGS. 3, 4, the board 40 preferably includes one or more horizontal grooves 40a and one or more vertical grooves 40b for guiding the moving apparatus 15, 15A and for preventing the moving apparatus 15, 15A from interfering the operation of the movable devices 24, 25 and the shafts 28, 29 of the guiding device 26. The movable devices 24, 25 may be moved up and down relative to the boards 40, and the guiding device 26 may also be moved up and down relative to the boards 40 even when the moving apparatus 15, 15A moves the wafers W between the receptacles 12a-12c.

As shown in FIGS. 1, 3, the unloading station C also includes a number of supporting stations 46, such as five supporting stations 46a, 46b, 46c, 46d, 46e, a conveyer device 47 for moving the carrier box 1 between the supporting stations 46a-46d, and another conveyer device 48 for moving the carrier box 1 between the supporting stations 46d and 46e. The unloading station also includes an elevating device 50 for moving the carrier boxes 1 upward and downward, a retaining device 51 for aligning the carrier boxes 1, and a transferring device 52 for moving the carrier boxes 1, similar to that of the loading station A. The moving device E may move the emptied carrier box 1 from the loading station A to the unloading station C for receiving the wafers W after being cleaned, and includes a casing 53b secured to a track 53 with a bracket 53a or the like.

In operation, as shown in FIGS. 1, 3 the conveyer device 4 may move the emptied carrier box 1 to the supporting station 2e, the seat 4d and the actuator 4c may be maintained in the upward extending position as shown in FIG. 5. The casing 53a may then be moved along the track 53 and along the direction indicated by the arrow 92 toward the supporting station 2e for receiving the emptied carrier box 1 after the seat 4d is lowered by the actuator 3c, and may then be moved along the direction indicated by the arrow 91 toward the drying device 14 for receiving and carrying the wafers W after cleaned. The conveyer device 4S may then take over the carrier box 1. The control device F may be used for controlling the operation of the devices or members or elements of the wafer cleaning apparatus as stated hereinafter.

The wafers W are moved from the supporting station 2a to the supporting member 7h of the retaining device 7. The grasping arms 27 may then grasp and move the wafers W through the receptacles 12a-12c, 13a-13c, step by step or receptacle by receptacle. The elevating device 19 may lower the grasping arms 27 to dip or immerge the wafers W into the solutions contained in the receptacles for allowing the wafers W to be cleaned by the chemical solutions and water. The grasping arms 27 may be cleaned by the cleaning device 10 after engaging with each kind of the chemical solutions. The wafers W are preferably cleaned by the chemical solution of the receptacle 12a first, and moved to the receptacle 13a so as to be cleaned by the water, and then moved to the other receptacle 12b so as to be cleaned by the other chemical solution, and then through the receptacle 13b, and then the other receptacle 12c by the further chemical solution, and then the receptacle 13c. The wafers W are then moved to the drying device 14 so as to be dried, and will then be moved to and supported by the supporting members 50h, 51h (FIG. 3) of the unloading station C, and then moved out through the opening 49b of the partition 49 by levers 49a and the other moving or transferring devices.

Accordingly, the wafer cleaning apparatus in accordance with the present invention may be used for cleaning various kinds of wafers.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An apparatus comprising:
a plurality of wafers,
at least one receptacle for receiving a cleaning agent and for receiving said wafers to clean said wafers, and
means for moving said wafers toward and into said at least one receptacle to clean said wafers.

2. An apparatus comprising:
a plurality of wafers,
a first receptacle for receiving a cleaning agent and a second receptacle for receiving water and for receiving said wafers to clean said wafers, and
means for moving said wafers toward and into said first and said second receptacles to clean said wafers.

3. The apparatus according to claim 2, wherein said cleaning agent is a chemical solution.

4. The apparatus according to claim 2 further comprising a housing for receiving said first and said second receptacles, and means for drawing air out of said housing.

5. The apparatus according to claim 2 wherein said wafer moving means includes a carrier box for receiving said wafers, means for elevating said wafers, means for grasping said wafers, and means for transferring said wafers toward and into said first and said second receptacles.

6. The apparatus according to claim 5, wherein said grasping means includes a pair of grasping arms, and means for forcing said grasping arms to grasp said wafers.

7. The apparatus according to claim 6, wherein said grasping arms each includes a plurality of grooves formed therein for receiving and retaining said wafers.

8. The apparatus according to claim 5, wherein said transferring means includes a track, a pair of grasping arms, and moving said grasping arms along said track and toward said first and said second receptacles.

9. The apparatus according to claim 8 further comprising means for cleaning said grasping arms.

10. The apparatus according to claim 8, wherein said grasping arms moving means includes a first rod and at least one second rod, a pair of first limbs secured to said at least one second rod, a pair of second limbs slidably secured on said first rod and said at least one second rod, and means for adjusting said first limbs relative to said second limbs.

11. The apparatus according to claim 10 further comprising a retainer secured between said first limbs and having a plurality of slots formed therein for receiving and retaining said wafers.

12. The apparatus according to claim 10 further comprising means for adjustably securing said second limbs relative to said first rod to any selected angular position.

13. The apparatus according to claim 12, wherein said adjustably securing means includes two blocks secured on said first rod, and two fasteners threaded to said second limbs respectively and engaged with said blocks respectively for adjusting said second limbs relative to said first rod to any selected angular position.

14. An apparatus comprising:
a plurality of wafers,
at least two first receptacles for receiving cleaning agents and at least two second receptacles for receiving water and for receiving said wafers to clean said wafers, and
means for moving said wafers toward and into said at least two first and said at least two second receptacles to clean said wafers.
